(19) United States
(12) Patent Application Publication
(10) Pub. No.: US 2016/0357706 A1
(43) Pub. Date: Dec. 8, 2016

(54) FAST FOURIER TRANSFORM DEVICE, FAST FOURIER TRANSFORM METHOD, AND STORAGE MEDIUM HAVING FAST FOURIER TRANSFORM PROGRAM STORED THEREON

(71) Applicant: NEC Corporation, MInato-ku, Tokyo (JP)

(72) Inventor: Atsufumi SHIBAYAMA, Tokyo (JP)

(21) Appl. No.: 15/103,117

(22) PCT Filed: Nov. 19, 2014
(86) PCT No.: PCT/JP2014/005804

§ 371 Date: Jun. 9, 2016

(30) Foreign Application Priority Data
Dec. 13, 2013 (JP) 2013-258271

(51) Int. Cl. G06F 17/14

(52) U.S. Cl. CPC G06F 17/142

(57) ABSTRACT

[Problem] To provide a fast Fourier transform device that makes it possible to input data to be processed and output a processing result in a desired order. [Solution] A fast Fourier transform device that is provided with: a first transform means that performs a fast Fourier transform or an inverse fast Fourier transform, generates a plurality of pieces of first output data, and outputs the result in a first order; and a first data sorting processing unit that sorts the plurality of pieces of first output data that are output in the first order into a second order in accordance with an output order setting that is based on a first movement amount.

### TECHNICAL FIELD

The present invention relates to calculation processing in digital signal processing, and more particularly to a fast Fourier transform device, a fast Fourier transform method, and a storage medium having a fast Fourier transform program stored thereon.

### BACKGROUND ART

Important processing types in digital signal processing include fast Fourier transform (hereinafter referred to as “FFT”) processing. Further, as a technology of compensating for waveform distortion in signal transmission in wireless communication and wired communication, for example, a frequency domain equalization (FDE) technology is known. In frequency domain equalization, signal data in a time domain are first transformed into data in a frequency domain by fast Fourier transform, and next, filter processing for equalization is performed. Then, data after the filter processing are retransformed into signal data in a time domain by inverse fast Fourier transform (hereinafter referred to as “IFFT”) so that waveform distortion in the original signal in a time domain is compensated for. FFT and IFFT are hereinafter referred to as “FFT/IFFT” when they are not distinguished.

In general, “butterfly calculation” is used in FFT/IFFT processing. An FFT device using butterfly calculation is described in, for example, PTL 1. PTL 1 also describes “twiddle multiplication” to be described later, that is, multiplication using a twiddle coefficient.

As an efficient FFT/IFFT processing method, for example, butterfly calculation by Cooley-Tukey described in NPL 1 is well known. However, the FFT/IFFT processing method by Cooley-Tukey has a large number of points, and therefore a circuit for providing the processing method is complex. Consequently, FFT/IFFT processing is performed by breaking down an FFT/IFFT into two smaller-sized FFT/IFFTs by use of, for example, a prime factor method described in NPL 2.

FIG. 14 illustrates, for example, a data flow 500 of a 64-point FFT broken down into sets of two-stage radix-8 butterfly processing by use of the prime factor method. The data flow 500 includes data sorting processing 501, a total of 16 sets of radix-8 butterfly calculation processing composed of butterfly calculation processing 502 and 503, and twiddle multiplication processing 504.

In the data flow illustrated in FIG. 14, input time-domain data x(n) (n=0, 1, . . . , 63) are Fourier-transformed into a frequency-domain signal X(k) (k=0, 1, . . . , 63) by FFT processing. In the example illustrated in FIG. 14, illustration of part of the data flow is omitted. Note that a basic configuration of the data flow illustrated in FIG. 14 is the same for IFFT processing.

An enormous circuit scale is required in order to provide the entire data flow illustrated in FIG. 14 by a circuit. Consequently, a method of providing the entire FFT processing by repetitive use of a circuit providing part of the processing of the data flow, depending on required processing performance, is common.

For example, in the data flow illustrated in FIG. 14, when an FFT device performing FFT processing on eight pieces of data in parallel (hereinafter simply referred to as “in 8-data-parallel”) is created as a physical circuit, 64-point FFT processing can be provided by a total of eight sets of repetitive processing.

The eight sets of repetitive processing represent successively performing processing corresponding to each of partial data flows 505a to 505h performed on eight pieces of data, and are specifically performed as follows. That is, processing corresponding to the partial data flow 505a is performed in a first round, processing corresponding to the partial data flow 505b is performed in a second round, and processing corresponding to the partial data flow 505c (not illustrated) is performed in a third round. Thereafter, processing is successively performed in a similar manner up to processing corresponding to the partial data flow 505h in an eighth round. The processing described above provides the 64-point FFT processing.

In butterfly calculation, data arranged in sequential order are read in an order conforming to a predetermined rule, and processed. Thus, data sorting is required in butterfly calculation, and a random access memory (RAM) is used for the purpose. An FFT device performing data sorting using a RAM in butterfly calculation is described in, for example, PTL 2.

Further, as for an FFT calculation device with a reduced memory usage amount, an acceleration technology by parallel processing of butterfly calculation is described in, for example, PTL 3.

### CITATION LIST

### Patent Literature

[PTL 1] Japanese Unexamined Patent Application Publication No. H8-137832 (pp. 3-5, FIG. 25)

[PTL 2] Japanese Unexamined Patent Application Publication No. 2001-56806 (p. 5, FIG. 1)

[PTL 3] Japanese Unexamined Patent Application Publication No. 2012-22500 (p. 5, FIG. 1)

### Non Patent Literature

[NPL 1] J. W. Cooley, J. W. Tukey, “An Algorithm for the Machine Calculation of Complex Fourier Series,” Mathematics of Computation, US, American Mathematical Society, April 1965, Vol. 19, No. 90, pp. 297-301

[NPL 2] D. P. Kolba, “A Prime Factor FFT Algorithm Using High-Speed Convolution,” IEEE Trans. on Acoustics, US, IEEE Signal Processing Society, August 1977, Vol. 29, No. 4, pp. 281-294

### SUMMARY OF INVENTION

### Technical Problem

Applications of a digital filter include “frequency offset compensation processing.” The frequency offset compensation processing can be provided by shifting a frequency spectrum on a frequency axis. Consequently, the frequency offset compensation processing can be efficiently implemented on a frequency-domain filter, and is used in FDE processing and the like.

As a specific example, a case of performing frequency offset compensation on a frequency-domain signal X(k) (where k denotes a frequency number representing a discrete frequency: k=0, 1, . . . , N−1, where N is a natural number), obtained by Fourier-transforming a time-domain signal x(n) (where n denotes a time number representing a discrete time: n=0, 1, . . . , N−1) by FFT, will be described. In order to perform frequency offset compensation by a compensation amount D (where D is an integer), a value of a frequency number k may be shifted by the compensation amount D. Consequently, a frequency-domain signal X′(k) (k=0, 1, . . . , N−1) added with a frequency offset of the compensation amount D is respectively expressed as follows, depending on the sign of D.
1) When D>0 (offset added for a shift in a direction toward high frequency):

$$\begin{matrix}{X}^{′} ( k ) = X ( k - D + N ) & ( when 0 \leq k < D ) \\ X ( k - D ) & ( when D \leq k < N / 2 ) \\ 0 & ( when N / 2 \leq k < N / 2 + D ) \\ X ( k - D ) & ( when N / 2 + D \leq k < N )\end{matrix}$$

2) When D<0 (offset added for a shift in a direction toward low frequency):

$$\begin{matrix}{X}^{′} ( k ) = X ( k - D ) & ( when 0 \leq k < N / 2 + D ) \\ 0 & ( when N / 2 + D \leq k < N / 2 ) \\ X ( k - D ) & ( when N / 2 \leq k < N + D ) \\ X ( k - D - N ) & ( when N + D \leq k < N )\end{matrix}$$

3) When D=0 (no shift):

X′(k)=X(k)(0≦k<N)

Thus, a frequency number of a signal after frequency offset compensation has a predetermined deviation from the frequency number of the signal before compensation, depending on a value of the frequency number. In general, signal processing in a frequency domain is performed in order of frequency number with processing of a frequency number as one cycle. Therefore, processing of the signal X′(k) after frequency offset compensation and processing of the signal X(k) before compensation cannot be performed in a same cycle. Consequently, in order to provide frequency offset compensation, the processing cycle of the frequency-domain signal X(k) (k=0, 1, . . . , N−1) needs to be shifted to a cycle different from the cycle to which the signal X(k) is input. In this case, it is desirable that the signal X(k) be input to a cycle as close to the destination cycle to which the processing cycle of the signal X(k) is shifted as possible. The reason is that, in order to shift the processing cycle of the signal X(k) to a different cycle, the signal X(k) needs to be retained from the cycle to which the signal X(k) is input to the destination cycle, and the retention of the signal X(k) causes decrease in entire processing speed.

Thus, in order to perform high-speed frequency offset compensation in a succeeding stage of FFT processing, that is, in a frequency domain, it is effective to input a signal representing an FFT processing result to the succeeding stage at a desired timing. It is generally effective to make an output order optimum for processing in a succeeding stage when outputting a signal representing an FFT processing result to the succeeding stage, being not limited to frequency offset compensation processing.

However, FFT circuits described in NPL 1 and 2 do not output a signal X(k) representing an FFT processing result in an order considering accelerated calculation in a succeeding stage, and output the FFT processing result X(k) in order of calculation completion. In such a case, in order to provide processing in a frequency domain, such as a desired spectrum shift as described above, a data sorting means for sorting the FFT processing result X(k) in a desired order needs to be provided.

FIG. 15 illustrates a configuration example of an FFT device 600 in which a data sorting processing circuit 602 is connected to an FFT circuit 601 as a succeeding stage. The data sorting circuit 602 needs to include a storage means capable of retaining data corresponding to at least one FFT block. It is further desirable that an output timing or an output order to a succeeding stage, with respect to an individual processing result of a plurality of processing results, be optimum for processing in the succeeding stage.

However, the FFT circuits described in NPL 1 and 2 do not include a data sorting circuit, and therefore is not able to control an output timing nor an output order of a processing result. Consequently, there is a problem that a delay time (latency) in entire processing including FFT processing increases.

In FFT devices in PTL 2 and 3, output timings of a plurality of results obtained by FFT processing are not considered. The FFT device in PTL 2 performs sorting of input data to a butterfly calculation unit. The FFT calculation device in PTL 3 attempts to achieve acceleration by parallelization of butterfly calculation. However, even in the FFT devices in PTL 2 and 3, an output order of a signal representing an FFT processing result is not particularly considered. Consequently, signals are output in order of calculation completion of FFT processing, and the order is not necessarily suited for acceleration of processing in a succeeding stage. Therefore, the FFT devices in PTL 2 and 3 have the same problem as described above that a delay time in entire processing increases.

As described above, the technologies in NPL 1 and 2 and PTL 2 and 3 have a problem that an output timing and an output order of a processing result of FFT processing cannot be optimized.

It also holds true that optimization of a timing or an output order of a processing result is effective when processing using an IFFT processing result is performed in a succeeding stage of the IFFT processing.

Additionally, it may be considered that there is a case that an output order of a processing result in a preceding stage of FFT processing or IFFT processing is not optimum for an execution order of calculation in the FFT processing or the IFFT processing. In such a case, it is effective to sort input data from the preceding stage to make the order optimum for the FFT processing or the IFFT processing.

### OBJECT OF INVENTION

An object of the present invention is to provide a fast Fourier transform circuit, a fast Fourier transform processing method, and a storage medium having a fast Fourier transform program stored thereon, capable of performing input of processing target data and output of a processing result in an arbitrary order in FFT/IFFT processing in digital signal processing.

### Solution to Problem

A fast Fourier transform device, according to the present invention, comprises:

first transform means for performing fast Fourier transform or inverse fast Fourier transform to generate a plurality of pieces of first output data, and outputting the data in a first order; and

first data sorting processing means for sorting the plurality of pieces of first output data, which is output in the first order, into a second order, in accordance with an output order setting based on a first shift amount.

A fast Fourier transform device, according to the present invention, comprises:

second data sorting processing means for sorting a plurality of pieces of second input data, which is input in a third order, into a fourth order, in accordance with an input order setting based on a second shift amount; and

second transform means for performing fast Fourier transform or inverse fast Fourier transform on the plurality of pieces of second input data sorted in the fourth order.

A fast Fourier transform method, according to the present invention, comprises:

performing sorting of a plurality of pieces of output data generated by fast Fourier transform or inverse fast Fourier transform, in accordance with an output order setting based on a first shift amount setting; or

performing sorting of a plurality of pieces of input data to the fast Fourier transform or the inverse fast Fourier transform, in accordance with an input order setting based on a second shift amount setting.

A storage medium, according to the present invention, stores a fast Fourier transform program which causes a computer included in a fast Fourier transform device to function as:

means for performing fast Fourier transform or inverse fast Fourier transform; and

sorting means for sorting a plurality of pieces of output data generated by the fast Fourier transform or the inverse fast Fourier transform, in accordance with an output order setting based on a first shift amount setting, or sorting means for sorting a plurality of pieces of input data to the fast Fourier transform or the inverse fast Fourier transform, in accordance with an input order setting based on a second shift amount setting.

### Advantageous Effects of Invention

The present invention is able to perform input of processing target data and output of a processing result in an arbitrary order in FFT/IFFT processing in digital signal processing.

### BRIEF DESCRIPTION OF DRAWINGS

FIG. 1 is a block diagram illustrating a configuration of an FFT device 10 according to a first exemplary embodiment of the present invention.

FIG. 2 is a diagram illustrating an arrangement of data sets conforming to a sequential order according to the first exemplary embodiment of the present invention.

FIG. 3 is a diagram illustrating an arrangement of data sets conforming to a bit-reversed order according to the first exemplary embodiment of the present invention.

FIG. 4 is a diagram illustrating an arrangement of data sets conforming to an arbitrary data set sequential order according to the first exemplary embodiment of the present invention.

FIG. 5 is a block diagram illustrating a configuration example 100 of a first data sorting circuit 11 and a second data sorting circuit 12 according to the first exemplary embodiment of the present invention.

FIG. 6 is a block diagram illustrating a configuration example 200 of a third data sorting processing circuit 13 according to the first exemplary embodiment of the present invention.

FIG. 7 is a block diagram illustrating a configuration of an IFFT device 20 according to a second exemplary embodiment of the present invention.

FIG. 8 is a block diagram illustrating a configuration example 300 of a first data sorting processing circuit 14 according to the second exemplary embodiment of the present invention.

FIG. 9 is a block diagram illustrating a configuration of an FFT device 30 according to a third exemplary embodiment of the present invention.

FIG. 10 is a diagram illustrating an arrangement of data sets conforming to an arbitrary data set bit-reversed order according to the third exemplary embodiment of the present invention.

FIG. 11 is a block diagram illustrating a configuration of an IFFT device 40 according to a fourth exemplary embodiment of the present invention.

FIG. 12A is a block diagram illustrating an essential configuration included in a fast Fourier transform device according to the present invention.

FIG. 12B is a block diagram illustrating an essential configuration included in a fast Fourier transform device according to the present invention.

FIG. 12C is a block diagram illustrating an essential configuration included in a fast Fourier transform device according to the present invention.

FIG. 13 is a block diagram illustrating a configuration example of a digital filter circuit 400 according to a fifth exemplary embodiment of the present invention.

FIG. 14 is a diagram illustrating a data flow 500 of 64-point FFT processing using two-stage butterfly calculation.

FIG. 15 is a block diagram illustrating a configuration of an FFT device 600 including a data sorting circuit.

### DESCRIPTION OF EMBODIMENTS

### First Exemplary Embodiment

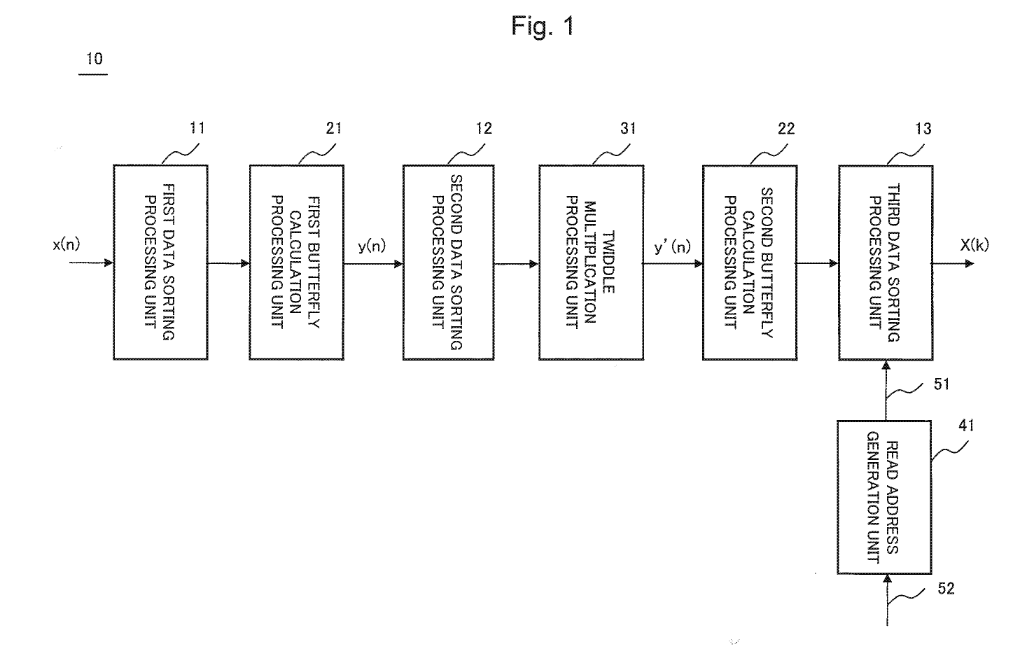

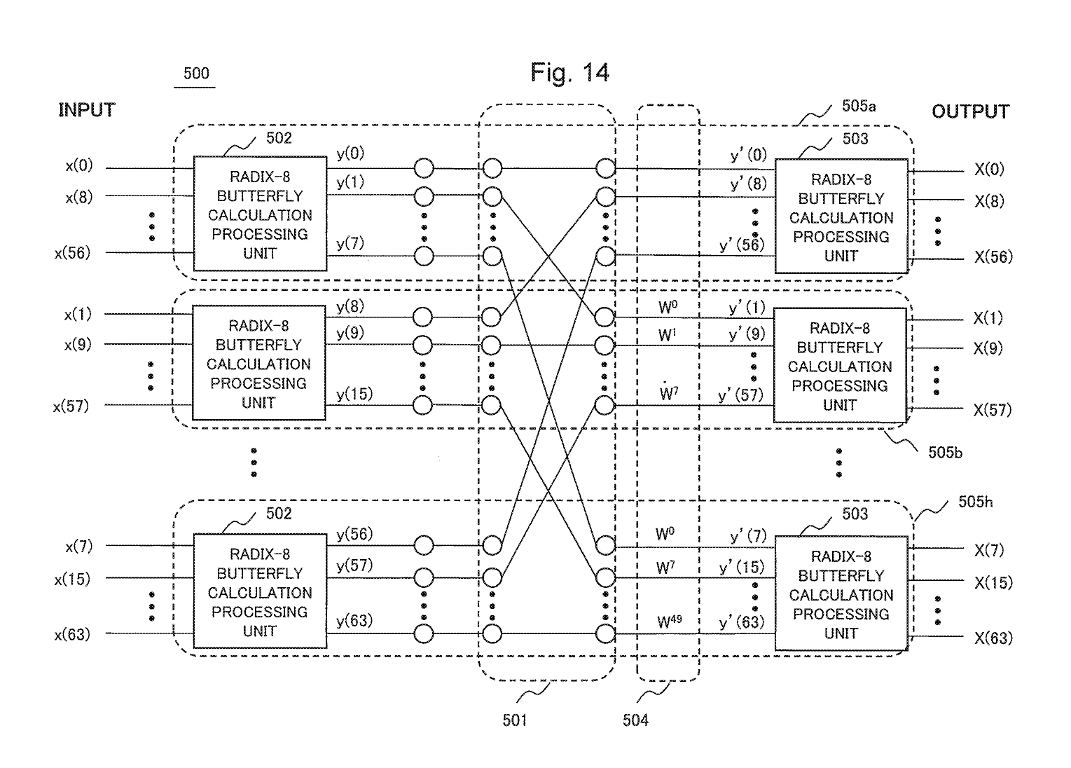

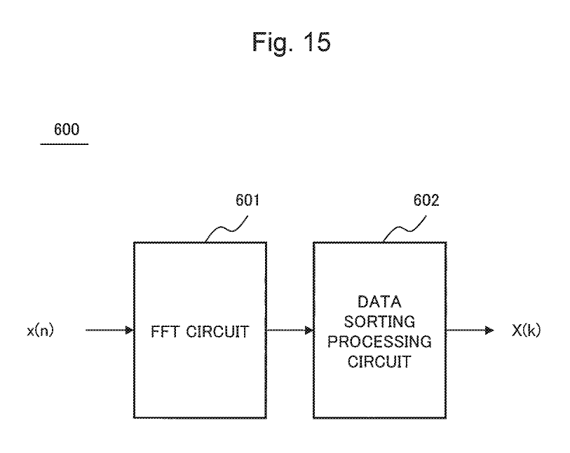

FIG. 1 is a block diagram illustrating a configuration example of an FFT device 10 according to a first exemplary embodiment of the present invention. The FFT device 10 processes a 64-point FFT broken down into sets of two-stage radix-8 butterfly processing, in accordance with the data flow 500 illustrated in FIG. 14, by a pipeline circuit method. When time-domain data x(n) (n=0, 1, . . . , N−1) are input, the FFT device 10 Fourier-transforms x(n) by FFT processing to generate and output a frequency-domain signal X(k) (k=0, 1, . . . , N−1). Note that N is a positive integer denoting an FFT block size.

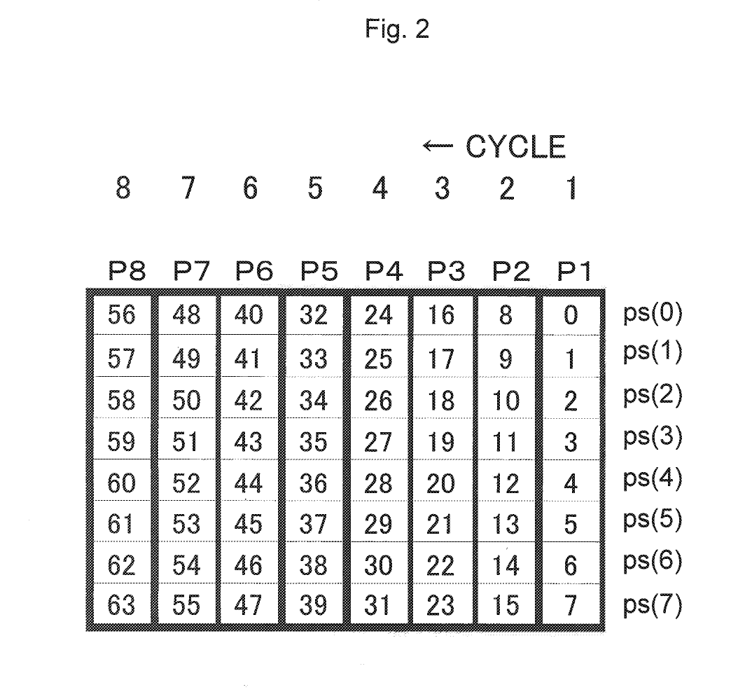

The FFT device 10 is assumed to perform 64-point FFT processing in 8-data-parallel. In this case, the FFT circuit 10 inputs time-domain data x(n), and generates and outputs a frequency-domain signal X(k) Fourier-transformed by FFT processing. At this time, a total of 64 pieces of data are input as input data x(n) by eight pieces of data in a period of eight cycles in an order illustrated in FIG. 2. Note that each of numbers from 0 to 63 indicated as contents of the table in FIG. 2 denotes an index n of x(n).

Specifically, eight pieces of data x(0), x(1), . . . , x(7) composing a data set P1 are input in the first cycle. Then, eight pieces of data x(8), x(9), . . . , x(15) composing a data set P2 are input in the second cycle. Thereafter, data composing data sets P3 to P8 are similarly input in the third to eighth cycles, respectively.

Similarly, 64 pieces of data are output as output data X(k) by eight pieces of data in a period of eight cycles in an order illustrated in FIG. 2. Note that each of numbers 0 to 63 indicated as contents of the table in FIG. 2 denotes an index k of X(k).

Specifically, eight pieces of data X(0), X(1), . . . , X(7) composing a data set P1 are output in the first cycle. Eight pieces of data X(8), X(9), . . . , X(15) composing a data set P2 are output in the second cycle. Thereafter, data composing data sets P3 to P8 are similarly output in the third to eighth cycles, respectively.

The FFT device 10 includes a first data sorting processing unit 11, a first butterfly calculation processing unit 21, a second data sorting processing unit 12, a twiddle multiplication processing unit 31, a second butterfly calculation processing unit 22, a third data sorting processing unit 13, and a read address generation unit 41. The FFT device 10 performs pipeline processing on first data sorting processing, first butterfly calculation processing, second data sorting processing, twiddle multiplication processing, second butterfly calculation processing, and third data sorting processing.

The first data sorting processing unit 11 and the second data sorting processing unit 12 are buffer circuits for data sorting. The first data sorting processing unit 11 and the second data sorting processing unit 12 perform sorting of data sequences based on data dependence in an FFT processing algorithm, before and after the first butterfly calculation processing unit 21, respectively.

Similarly, the third data sorting processing unit 13 is also a buffer circuit for data sorting. In other words, the third data sorting processing unit 13 performs sorting of data sequences based on data dependence in an FFT processing algorithm, after the second butterfly calculation processing unit 22. In addition to the sorting described above, the third data sorting processing unit 13 further performs sorting processing on an output X(k) of the FFT device 10. The additional sorting enables a processing cycle shift of the output X(k) and the like for providing, for example, the aforementioned frequency spectrum shift.

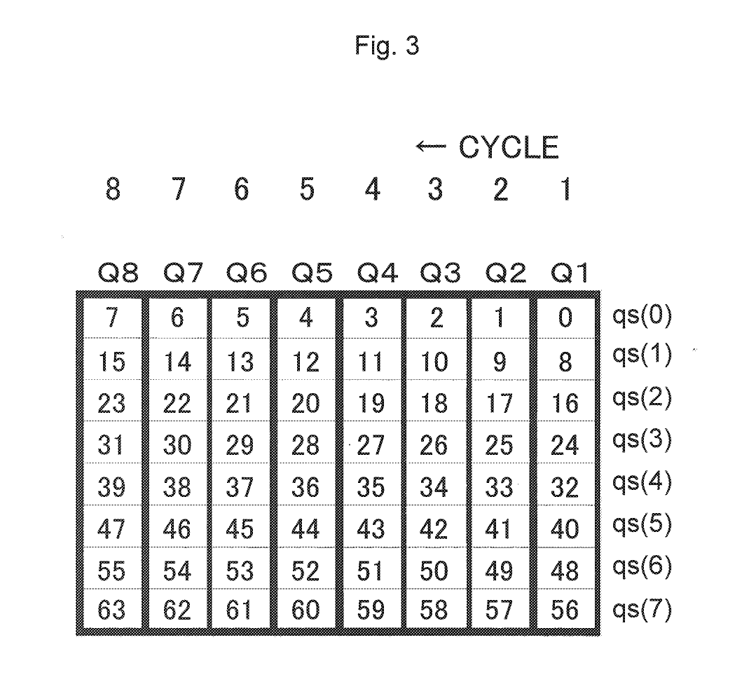

Specifically, the first data sorting processing unit 11 sorts input data x(n) in a “sequential order” illustrated in FIG. 2, which is an input order, into a “bit-reversed order” illustrated in FIG. 3, which is an order of input to the first butterfly calculation processing unit 21.

The bit-reversed order illustrated in FIG. 3 corresponds to a data set input to radix-8 butterfly processing 502 in the first stage in the data flow diagram illustrated in FIG. 14. Specifically, eight pieces of data x(0), x(8), . . . , x(56) composing a data set P1 are input in the first cycle. Then, eight pieces of data x(1), x(9), . . . , x(57) composing a data set P2 are input in the second cycle. Thereafter, data composing data sets P3 to P8 are similarly input in the third to eighth cycles, respectively.

The “sequential order” and the “bit-reversed order” will be specifically described here. The “sequential order” refers to an order of eight data sets P1, P2, P3, P4, P5, P6, P7, and P8 illustrated in FIG. 2. Each data set Ps (where s denotes a value indicating an order of a processing cycle: s=1, . . . , 8) is composed of eight pieces of data arranged in an order of ps(0) to ps(7), where ps(i) is given by ps(i)=8(s−1)+i. Further, each data set is arranged in an order of P1, P2, P3, P4, P5, P6, P7, and P8 corresponding to progression of processing cycles. In other words, the sequential order represents creating s sets of data sets by taking every i pieces of data from the leading data out of i×s pieces of data and arranging the data in order of data, and then arranging the data sets in order of cycle.

The “bit-reversed order” refers to an order of eight data sets Q1, Q2, Q3, Q4, Q5, Q6, Q7, and Q8 illustrated in FIG. 3. Each data set Qs is composed of eight pieces of data from qs(0) to qs(7), where qs(i) is given by

qs(i)=(s−1)+8i.

Further, each data set is arranged in an order of Q1, Q2, Q3, Q4, Q5, Q6, Q7, and Q8 corresponding to progression of processing cycles. In other words, the bit-reversed order represents arranging every s pieces of data from the leading data in order of cycle out of i×s pieces of data input in the sequential order, and then arranging i pieces of data in a same cycle as a set in order of data.

As described above, each data set in the bit-reversed order is uniquely determined once each set in the sequential order is set. An i-th piece of data of the data composing each data set Qs (s=1, . . . , 8) in the bit-reversed order is an s-th piece of data in a cycle i conforming to the sequential order. In other words, the following expression holds:

Qs(i)=Pi(s)

Thus, Qs(i) and Pi(s) have a relation of interchanging an order corresponding to progression of cycles and an order corresponding to data positions with respect to data composing each data set. Therefore, sorting data input in the bit-reversed order in accordance with the bit-reversed order results in the data arranged in the sequential order.

Each row ps(i) in FIG. 2 and eight rows qs(i) in FIG. 3 respectively represent data input to an i-th piece of data in a next stage. Each of eight numbers included in each data set represents identification information specifying one of FFT points, and specifically is a value of an index n of x(n).

Sorting between the data set Ps in FIG. 2 and the data set Qs in FIG. 3, that is, interchanging a correspondence of each data set with identification information included therein, may be performed in another data sorting circuit described in and after a second exemplary embodiment.

Note that a sequential order and a bit-reversed order are not limited to the exemplifications in FIGS. 2 and 3. In other words, each data set in a sequential order may be created by arranging data sequentially in accordance with a number of FFT points, a number of cycles, and a number of pieces of data processed in parallel, as described above. Further, each data set in a bit-reversed order may be created by interchanging an order corresponding to progression of cycles and an order corresponding to data positions with respect to data input in a sequential order as described above.

The first butterfly calculation processing unit 21 is a butterfly circuit processing the first-stage butterfly calculation processing 502 (first butterfly calculation processing) of radix-8 butterfly calculation processing performed twice in the data flow 500 in FIG. 14. The first butterfly calculation processing unit 21 outputs the result of butterfly calculation processing as data y(n) (n=0, 1, . . . , 63) in the sequential order illustrated in FIG. 2.

The second data sorting processing unit 12 sorts data y(n), output from the first butterfly calculation processing unit 21 in the sequential order, into the bit-reversed order illustrated in FIG. 3 to input the data to the second butterfly calculation processing unit 22.

The twiddle multiplication processing unit 31 is a circuit processing complex rotation in a complex plane in FFT calculation after the first butterfly calculation processing, corresponding to twiddle multiplication processing 504 in the data flow 500 in FIG. 14. Note that data sorting is not performed in the twiddle multiplication processing.

The second butterfly calculation processing unit 22 is a butterfly circuit processing second-stage radix-8 butterfly processing 503 in the data flow diagram in FIG. 14. The second butterfly calculation processing unit 22 performs butterfly calculation processing on data y′(n) (n=0, 1, . . . , 63) after the twiddle multiplication processing, input in the bit-reversed order, and outputs the result X(k) (n=0, 1, . . . , 63) also in the bit-reversed order.

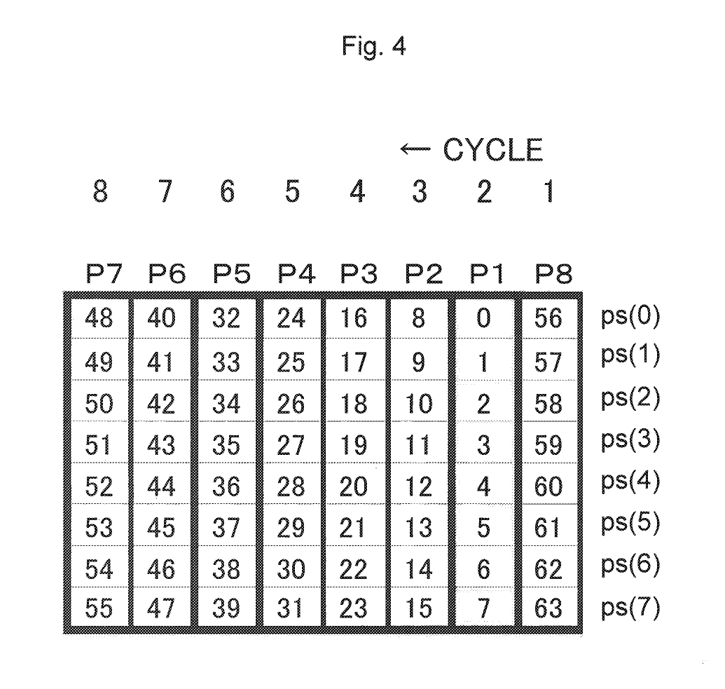

The third data sorting processing unit 13 sorts data X(k), output from the second butterfly calculation processing unit 22 in the bit-reversed order, into an order illustrated in FIG. 4 (hereinafter referred to as “arbitrary data set sequential order”). The “arbitrary data set sequential order” is an order output by the FFT device 10 as the final result of the FFT processing. The arbitrary data set sequential order is an order used when s pieces of data sets Ps created in the sequential order are output in accordance with cycle progression, and may be specified by a frequency offset setting 52. The present exemplary embodiment specifies the arbitrary data set sequential order as an order of P8, P1, P2, P3, P4, P5, P6, and P7.

Each row ps(i) in FIG. 4 represents data input to an i-th piece of data in a next stage. Each of eight numbers included in each data set represents identification information specifying one of FFT points, and specifically is a value of an index k of X(k).

The third data sorting processing unit 13 determines an output order of the data X(k), in accordance with a read address 51 output by the read address generation unit 41.

The read address generation unit 41 generates the read address 51 by referring to the frequency offset setting 52 given by an upper circuit (not illustrated) such as a central processing unit (CPU), and outputs the address to the data sorting processing unit 13.

The data sorting processing units provide data sorting processing, in accordance with each of the sequential order illustrated in FIG. 2, the bit-reversed order illustrated in FIG. 3, and the arbitrary data set sequential order illustrated in FIG. 4, by temporarily storing input data and controlling selection and output of the stored data. A specific example of the data sorting processing units will be described below.

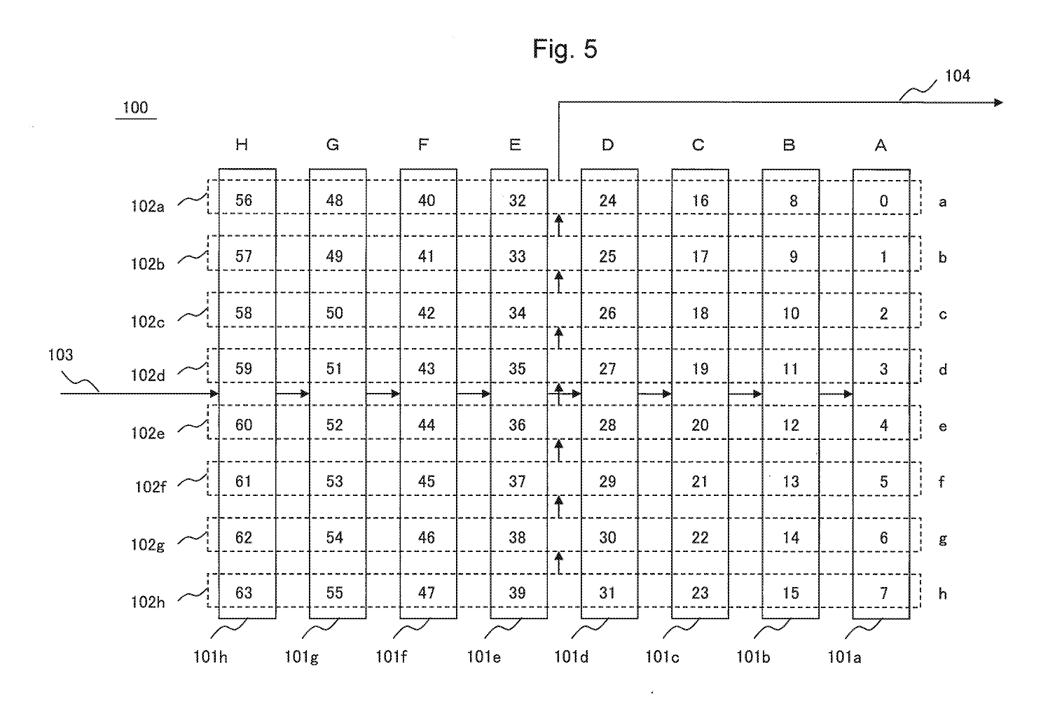

The first data sorting processing unit 11 and the second data sorting processing unit 12 may be implemented with, for example, a data sorting processing unit 100 illustrated in FIG. 5.

The data sorting processing unit 100 inputs data sets D1 to D8 composed of eight pieces of data, input as input information 103, in a first-in order in a first-in first-out buffer (FIFO buffer), writes the data sets into data storage locations 101a to 101h, and stores the data sets. Specifically, the data sets D1 to D8 are stored in the data storage locations 101a to 101h, respectively.

Next, the data sorting processing unit 100 outputs the stored data in a first-out order in a FIFO buffer. Specifically, the data sorting processing unit 100 takes eight pieces of data read from each of data read locations 102a to 102h to compose a data set, and outputs eight data sets D1′ to D8′ as output information 104. Thus, each of the data sets D1′ to D8′ is composed as a set by sorting data, being included in the data sets D1 to D8 arranged in order of cycle, into order of data position.

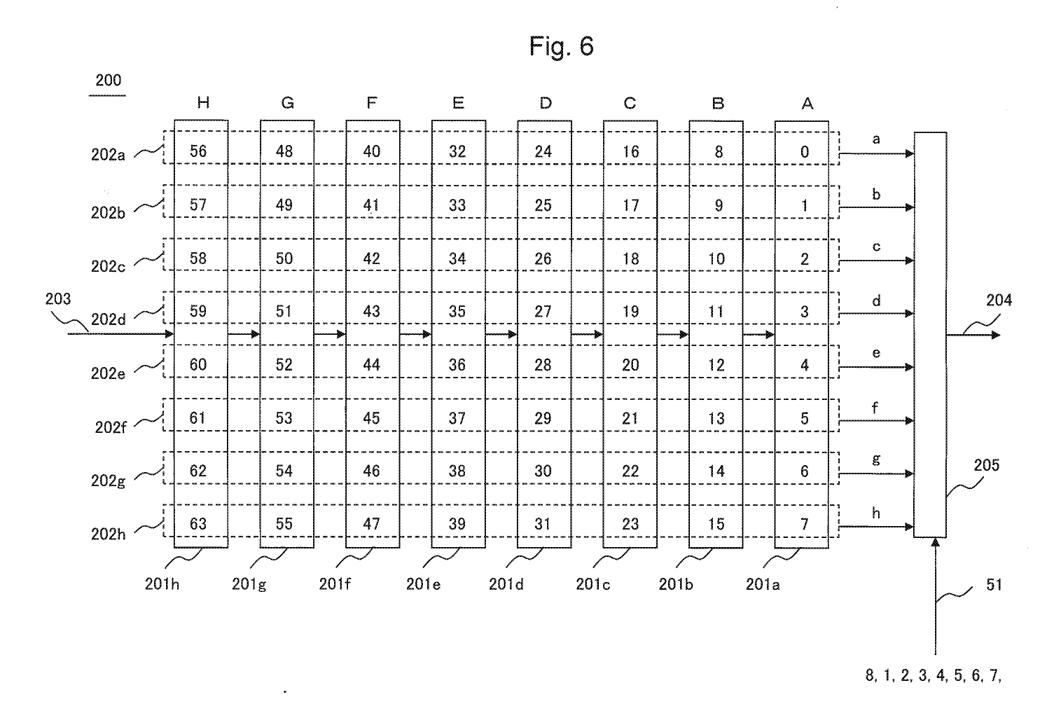

Meanwhile, FIG. 6 is a configuration diagram of a data sorting processing unit 200, illustrating an implementation example of the third data sorting processing unit 13. The data sorting processing unit 200 inputs data sets P1 to P8, composed of eight pieces of data input as input information 203, in a first-in order of a FIFO buffer, writes the data sets into data storage locations 201a to 201h, and stores the data sets. In other words, the data sets D1 to D8 are successively stored in the corresponding data storage locations 201a to 201h, respectively, in order of cycle. At this time, when the stored data are observed in order of data position, that is, in order of data storage location from 202a to 202h, data sets D1′ to D8′ are stored in the data storage locations 202a to 202h, respectively.

Next, the data sorting processing unit 200 reads the stored data by a read circuit 205 and outputs the data as output information 204. At this time, the read circuit 205 selects one of the data storage locations 202a to 202h by referring to the read address 51, and reads one of eight pieces of data stored in the data storage locations 202a to 202h with a single read operation. Thus, data can be read in an arbitrary order by giving read addresses to the read address 51 in an arbitrarily specifiable, desired order. For example, when the read address 51 is given read addresses in an order of addresses 8, 1, 2, 3, 4, 5, 6, and 7, the data sorting processing unit 200 outputs stored data in an order of the data sets D8′, Dr, D2′, D3′, D4′, D5′, D6′, and D7′. In other words, data are output in the arbitrary data set sequential order illustrated in FIG. 4. Note that each of the data sets D1′ to D8′ is composed as a set by sorting data, being included in the data sets D1 to D8 arranged in order of cycle, into order of data position.

As described above, in the FFT device 10, three sets of sorting processing conforming to the sequential order in FIG. 2, the bit-reversed order in FIG. 3, and the arbitrary data set sequential order in FIG. 4 are respectively performed by the first data sorting processing unit 11, the second data sorting processing unit 12, and the third data sorting processing unit 13.

Since data can be output at a desirable timing by respectively controlling the first data sorting processing unit 11, the second data sorting processing unit 12, and the third data sorting processing unit 13 as described above, no further data sorting is required. The sorting enables a processing cycle shift of the output X(k) and the like to provide, for example, the aforementioned frequency spectrum shift. Data sorting in the third data sorting processing unit 13 will be described below as an example.

A case of performing 64-point FFT processing in 8-data-parallel will be described as an example by use of the FFT device 10 illustrated in FIG. 1. When time-domain data x(n) (n=0, 1, . . . , 63) are input, the FFT device 10 generates and outputs a frequency-domain signal X(k) (k=0, 1, . . . , 63) Fourier-transformed by FFT processing. The input data x(n) are input by eight pieces of data in a period of eight cycles in the order illustrated in FIG. 2, and a total of 64 pieces of data x(n) are input. Note that only an index n of x(n) is indicated in FIG. 2.

Specifically, eight pieces of data x(0), x(1), . . . , x(7) composing a data set P1 are input in the first cycle. Then eight pieces of data x(8), x(9), . . . , x(15) composing a data set P2 are input in the second cycle. Thereafter, data composing data sets P3 to P8 are similarly input in the third to eighth cycles, respectively.

On the other hand, with respect to output data X(k), a total of 64 pieces of data are output by eight pieces of data in a period of eight cycles in, for example, the order illustrated in FIG. 4. Note that only an index k of X(k) is indicated in FIG. 4. Specifically, the following data are output in each cycle.

### First Cycle:

Eight pieces of data X(56), X(57), . . . , X(63) composing the data set D8 are output.

### Second Cycle:

Eight pieces of data X(0), X(1), . . . , X(7) composing the data set D1 are output.

### Third Cycle:

Eight pieces of data X(8), X(9), . . . , X(15) composing the data set D2 are output.

### Fourth Cycle:

Eight pieces of data X(16), X(17), . . . , X(23) composing the data set D3 are output.

### Fifth Cycle:

Eight pieces of data X(24), X(25), . . . , X(31) composing the data set D4 are output.

### Sixth Cycle:

Eight pieces of data X(32), X(33), . . . , X(39) composing the data set D5 are output.

### Seventh Cycle:

Eight pieces of data X(40), X(41), . . . , X(47) composing the data set D6 are output.

### Eighth Cycle:

Eight pieces of data X(48), X(49), . . . , X(55) composing the data set D7 are output.

In other words, a signal X′(k) after a frequency spectrum shift is output in the following cycles, depending on the value of k.

X′(k) (k=0 to 7): First cycle

X′(k) (k=8 to 15): Second cycle

X′(k) (k=16 to 23): Third cycle

X′(k) (k=24 to 31): Fourth cycle

X′(k) (k=32 to 39): Fifth cycle

X′(k) (k=40 to 47): Sixth cycle

X′(k) (k=48 to 55): Seventh cycle

X′(k) (k=56 to 63): Eighth cycle

The following relations hold here.

$$\begin{matrix}{X}^{′} ( k ) = X ( k - 8 + 64 ) & ( 0 \leq k < 8 ) \\ X ( k - 8 ) & ( 8 \leq k < 64 )\end{matrix}$$

A frequency-domain signal X′(k) obtained by adding a frequency offset of 8, with respect to a value of a frequency number k, to a frequency-domain signal X(k) in a direction toward high frequency is expressed as follows.

$$\begin{matrix}{X}^{′} ( k ) = X ( k - 8 + 64 ) & ( 0 \leq k < 8 ) \\ X ( k - 8 ) & ( 8 \leq k < 32 ) \\ 0 & ( 32 \leq k < 40 ) \\ X ( k - 8 ) & ( 40 \leq k < 64 )\end{matrix}$$

Consequently, an additional signal shift between different cycles is not required for generating the frequency-domain signal X′(k), and there is no need for an additional circuit for data sorting. In other words, the frequency spectrum of the frequency-domain signal X(k) (k=0, 1, . . . , 63) is shifted by 8 with respect to a value of a frequency number k, in a direction toward high frequency, to provide a desirable signal output order.

Thus, an output order of the FFT circuit can be controlled to provide a processing cycle shift, in accordance with the frequency offset setting 52.

### Effects of First Exemplary Embodiment

As described above, the FFT device 10 according to the present exemplary embodiment is able to output data in an arbitrary order, by specifying the order by use of the frequency offset setting 52.

For example, in order to provide a spectrum shift for compensation of a frequency offset in a succeeding stage of the FFT device 10, an output order of the FFT circuit can be output in accordance with a frequency offset amount. Consequently, there is no need for an additional circuit to perform additional sorting on the output.

Further, the only circuit to be added to make an output order of output data specifiable is the read address generation unit 41, and a circuit scale thereof is very small.

Therefore, increase in a circuit scale and power consumption as a whole, including processing in a succeeding stage, can be suppressed.

Note that, while the FFT processing according to the present exemplary embodiment has been described as an example, the same holds for IFFT. In other words, processing in a succeeding stage of IFFT processing can be accelerated by applying the control method according to the present exemplary embodiment to an IFFT processing device, and optimizing an output order of a processing result in consideration of the processing content in the succeeding stage of the IFFT processing.

Note that, when applying the method according to the present exemplary embodiment to IFFT processing, an output order of an IFFT processing result is specified by a “time offset amount” as a temporal shift amount instead of a “frequency offset amount” according to the present exemplary embodiment. Thus, the present exemplary embodiment changes an output order of a result of FFT processing or IFFT processing, depending on a frequency-based or time-based “shift amount,” respectively.

### Second Exemplary Embodiment

In contrast to the first exemplary embodiment, a processing result of a preceding stage of FFT/IFFT processing may be input to an FFT/IFFT processing device in an arbitrary order. Consequently, for example, a processing result of the preceding stage of the FFT/IFFT processing may be input to a processing device performing processing, requiring a processing cycle shift such as a frequency spectrum shift, in a desirable order for the processing. In this case, it is effective for acceleration of the FFT/IFFT processing and suppression of increase in a circuit scale and power consumption to sort the input processing result of the preceding stage into an order suitable for the FFT/IFFT processing.

An IFFT device according to a second exemplary embodiment operating in accordance with an arbitrary data set sequential order (such as the order illustrated in FIG. 4), as a desirable order for providing a processing cycle shift, will be described.

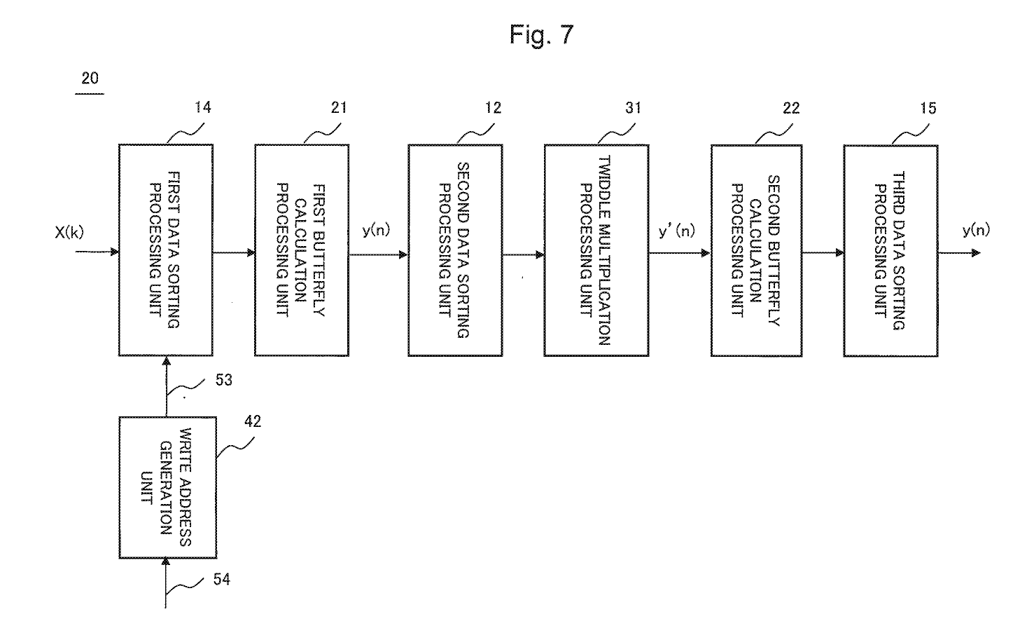

FIG. 7 is a block diagram illustrating a configuration example of the IFFT device 20 according to the second exemplary embodiment of the present invention. The IFFT device 20 processes a 64-point IFFT broken down into sets of two-stage radix-8 butterfly processing, in accordance with a data flow similar to the FFT data flow 500 illustrated in FIG. 14, by a pipeline circuit method. When a frequency-domain signal X(k) (k=0, 1, . . . , N−1) Fourier-transformed by the FFT device 10 is input, the IFFT device 20 generates time-domain data y(n) (n=0, 1, . . . , N−1) by inverse-Fourier-transforming X(k) and outputs the data. Note that N is a positive integer denoting an IFFT block size.

In FIG. 7, the IFFT device 20 performs 64-point IFFT processing in 8-data-parallel. The IFFT device 20 inputs an input X(k) in the arbitrary data set sequential order illustrated in FIG. 4, similar to an output of the FFT device 10. Additionally, the IFFT device 20 outputs an output y(n) in the sequential order illustrated in FIG. 2.

The IFFT device 20 includes a first data sorting processing unit 14, a first butterfly calculation processing unit 21, a second data sorting processing unit 12, a twiddle multiplication processing unit 31, a second butterfly calculation processing unit 22, a third data sorting processing unit 15, and a write address generation unit 42. The IFFT device 20 performs pipeline processing on first data sorting processing, first butterfly calculation processing, second data sorting processing, twiddle multiplication processing, second butterfly calculation processing, and third data sorting processing.

The first data sorting processing unit 14 is a buffer circuit for data sorting. In other words, the first data sorting processing unit 14 performs sorting of data sequences based on data dependence in an IFFT processing algorithm, before the first butterfly circuit 21. In addition to the sorting described above, the first data sorting processing unit 14 further performs sorting processing for inputting data in the arbitrary data set sequential order.

Specifically, the first data sorting processing unit 14 sorts the arbitrary data set sequential order illustrated in FIG. 4, as an input order of input data X(k), into the bit-reversed order illustrated in FIG. 3, as an order of input to the first butterfly calculation processing unit 21.

Similarly, the second data sorting processing unit 12, and the third data sorting processing unit 15 are also buffer circuits for data sorting. The second data sorting processing unit 12, and the third data sorting processing unit 15 perform sorting of data sequences based on data dependence in an IFFT processing algorithm, after the first butterfly calculation circuit 21 and the second butterfly calculation circuit 22, respectively.

The first butterfly calculation processing unit 21 is a butterfly circuit processing the first-stage butterfly calculation processing 502 (first butterfly calculation processing) of radix-8 butterfly calculation processing performed twice in the data flow 500 in FIG. 14. The first butterfly calculation processing unit 21 outputs the result of butterfly calculation processing as data y(n) (n=0, 1, . . . , 63) in the sequential order illustrated in FIG. 2.

The second data sorting processing unit 12 sorts data y(n), output from the first butterfly calculation processing unit 21 in the sequential order, into the bit-reversed order illustrated in FIG. 3 to input the data to the twiddle multiplication processing unit 31.

The twiddle multiplication processing unit 31 is a circuit processing complex rotation in a complex plane in IFFT calculation after the first butterfly calculation processing, corresponding to the twiddle multiplication processing 504 in the data flow 500 in FIG. 14. Note that data sorting is not performed in the twiddle multiplication processing.

The second butterfly calculation processing unit 22 is a butterfly circuit processing the second-stage radix-8 butterfly processing 503 in the data flow 500 in FIG. 14. The second butterfly calculation processing unit 22 performs butterfly calculation processing on data y′(n) (n=0, 1, . . . , 63) after the twiddle multiplication processing input in the bit-reversed order, and outputs the result X(k) (n=0, 1, . . . , 63) also in the bit-reversed order.

The third data sorting processing unit 15 sorts data X(k), output from the second butterfly calculation processing unit 22 in the bit-reversed order, into the sequential order in FIG. 2. In other words, the IFFT device 20 outputs the final result of the IFFT processing in the sequential order.

The first data sorting processing unit 14 determines an input order of data X(k), in accordance with a write address 53 output from the write address generation unit 42.

The write address generation unit 42 generates the write address 53 output to the data sorting processing unit 14 by referring to a frequency offset setting 54 given by an upper circuit (not illustrated) such as a CPU.

The second data sorting processing unit 12 and the third data sorting processing unit 15 may be implemented with, for example, the data sorting processing unit 100 illustrated in FIG. 5.

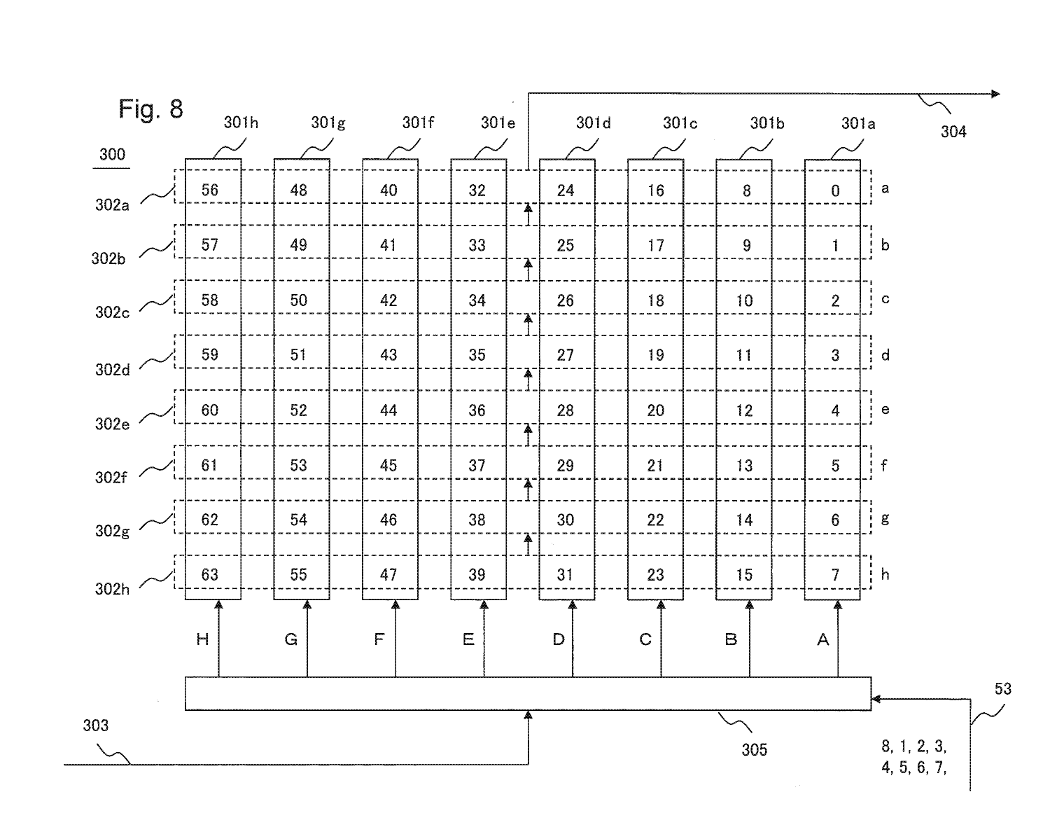

FIG. 8 is a configuration diagram of a data sorting processing unit 300 illustrating an implementation example of the first data sorting processing unit 14. The data sorting processing unit 300 writes data sets D1 to D8 composed of eight pieces of data, input in the arbitrary data set sequential order as input information 303, into write locations 301a to 301h with a write circuit 305. At this time, the write circuit 305 selects one of the write locations 301a to 301h by referring to the write address 53, and performs a single write operation. In other words, data can be written in a desired order by giving write addresses in a specified, predetermined order to the write address 53.

For example, when write addresses in an order of addresses 8, 1, 2, 3, 4, 5, 6, and 7 are given to the write address 53, the data sorting processing unit 300 writes data, input in an order of data sets D1, D2, D3, D4, D5, D6, D7, and D8, into the write locations 301a to 301h in an order of 301h, 301a, 301b, 301c, 301d, 301e, 301f, and 301g, and stores the data sets. In other words, the data sets D1 to D8 are stored in an order of D2, D3, D4, D5, D6, D7, D8, and D1 into the data storage locations 301a to 301h, respectively. At this time, when the stored data are observed in order of cycle, that is, in order of data storage location from 302a to 302h, data sets D1′ to D8′ are stored in the data storage locations 302a to 302h, respectively.

Next, the data sorting processing unit 300 reads and outputs the stored data in a first-out order in a FIFO buffer. Specifically, the data sorting processing unit 300 reads and outputs the data sets D1′ to D8′, respectively stored in the data storage locations 302a to 302h, in an order of D1′, D2′, D3′, D4′, D5′, D6′, D7′, and D8′.

In other words, the data sorting processing unit 300, corresponding to the first data sorting processing unit 14, is able to input data in a desirable order for a processing cycle shift by giving write addresses to the write address 53 in an arbitrarily specifiable, desired order. For example, when the write address 53 is given write addresses in an order of addresses 8, 1, 2, 3, 4, 5, 6, and 7, the data sorting processing unit 300 processes the data input in an order of the data sets D1, D2, D3, D4, D5, D6, D7, and D8 as data input in an order of D2, D3, D4, D5, D6, D7, D8, and D1.

In this case, an output signal X′(k) of the data sorting processing unit 300, in response to an input signal X (k) of the data sorting processing unit 300, is expressed as follows.

$$\begin{matrix}{X}^{′} ( k ) = X ( k + 8 ) & ( 0 \leq k < 56 ) \\ X ( k + 8 - 64 ) & ( 56 \leq k < 64 )\end{matrix}$$

A frequency-domain signal X′(k) obtained by adding a frequency offset of 8, with respect to a value of a frequency number k, to a frequency-domain signal X(k) in a direction toward low frequency is expressed as follows.

$$\begin{matrix}{X}^{′} ( k ) = X ( k + 8 ) & ( 0 \leq k < 24 ) \\ 0 & ( 24 \leq k < 32 ) \\ X ( k + 8 ) & ( 32 \leq k < 56 ) \\ X ( k + 8 - 64 ) & ( 56 \leq k < 64 )\end{matrix}$$

Consequently, an additional signal shift between different cycles is not required for generating the frequency-domain signal X′(k), and there is no need for an additional circuit for data sorting. In other words, the frequency spectrum of the frequency-domain signal X(k) (k=0, 1, . . . , 63) is shifted by 8 with respect to a value of a frequency number k, in a direction toward low frequency, to provide a desirable signal output order.

On the other hand, the data sorting processing unit 100, corresponding to the second data sorting processing unit 12 and the third data sorting processing unit 15, outputs stored data in an order of D1, D2, D3, D4, D5, D6, D7, and D8, that is, in the sequential order in FIG. 1.

### Effects of Second Exemplary Embodiment

As described above, the IFFT device 20 according to the present exemplary embodiment is able to input data in a desirable order for providing a processing cycle shift for a frequency spectrum shift and the like, by specifying the order by use of the frequency offset setting 54. Consequently, there is no need for additional sorting means with respect to input, adapting to an output order of the FFT device 10.

Further, the only circuit to be added to adapt to input data, input in an arbitrary order, is the write address generation unit 42 and a circuit scale thereof is very small.

Therefore, increase in a circuit scale and power consumption as a whole, including processing in a preceding stage, can be suppressed.

Note that, while the IFFT processing according to the present exemplary embodiment has been described as an example, the same holds for FFT. In other words, FFT processing can be accelerated by applying the control method according to the present exemplary embodiment to an FFT processing device, and optimizing an input order of an input signal in consideration of processing content in a preceding stage of the FFT processing.

Note that, when applying the method according to the present exemplary embodiment to FFT processing, an input order of data to the FFT processing is specified by a “time offset amount” as a temporal shift amount instead of a “frequency offset amount” according to the present exemplary embodiment. Thus, the present exemplary embodiment changes an input order of data to IFFT processing or FFT processing, depending on a frequency-based or time-based “shift amount,” respectively.

### Third Exemplary Embodiment

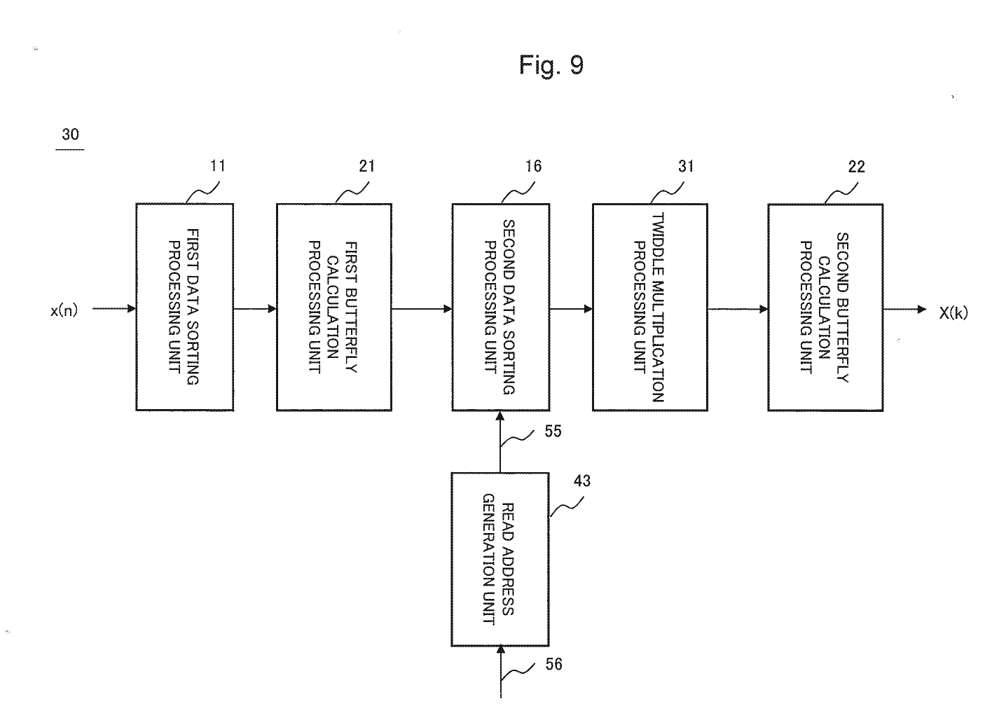

In the FFT device 10, the third data sorting processing unit 13 may be omitted by modifying the second data sorting processing unit 12. An FFT device 30, obtained by removing the third data sorting processing unit 13 from the FFT device 10, will be described with reference to FIG. 9.

FIG. 9 is a block diagram illustrating a configuration example of the FFT device 30 according to a third exemplary embodiment of the present invention. The FFT device 30 processes a 64-point FFT broken down into sets of two-stage radix-8 butterfly processing, in accordance with a data flow similar to the FFT data flow illustrated in FIG. 14, by a pipeline circuit method. When time-domain data x(n) (n=0, 1, . . . , N−1) are input, the FFT device 30 Fourier-transforms x(n) by FFT processing to generate and output a frequency-domain signal X(k) (k=0, 1, . . . , N−1). Note that N is a positive integer denoting an FFT block size.

A case of performing 64-point FFT processing in 8-data-parallel by use of the FFT device 30 illustrated in FIG. 9 will be described as an example. When time-domain data x(n) (n=0, 1, . . . , 63) are input, the FFT device 30 generates and outputs a frequency-domain signal X(k) (k=0, 1, . . . , 63) Fourier-transformed by FFT processing. The input data x(n) are input by eight pieces of data in a period of eight cycles, in the order illustrated in FIG. 2, and a total of 64 pieces of data x(n) are input.

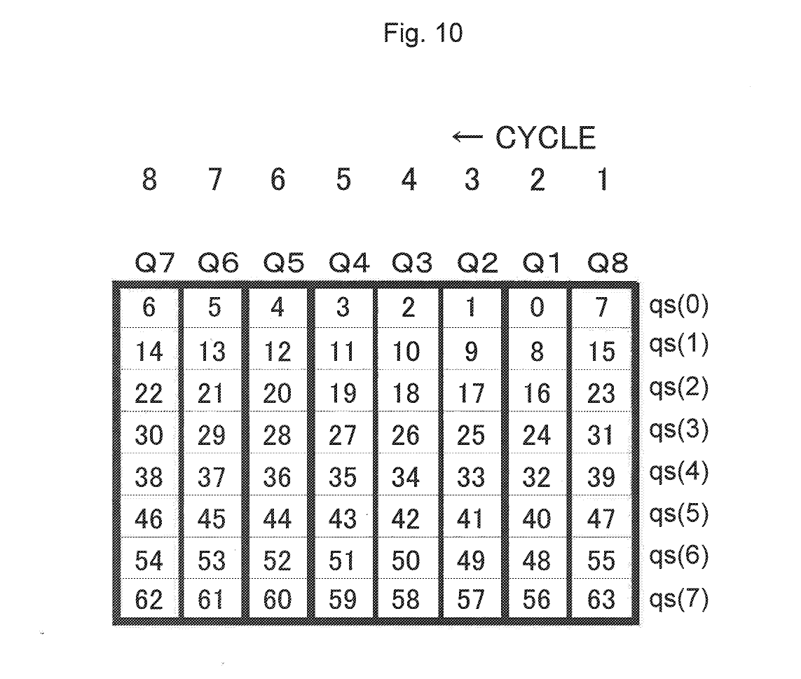

On the other hand, with respect to the output data X(k), a total of 64 pieces of data are output by eight pieces of data in a period of eight cycles in, for example, an order illustrated in FIG. 10 (hereinafter referred to as “arbitrary data set bit-reversed order”).

Each row qs(i) in FIG. 10 represents data input to an i-th piece of data in a next stage. Each of eight numbers included in each data set represents identification information specifying one of FFT points, and specifically is a value of an index k of x(k).

Specifically, the following data are output in each cycle.

### First Cycle:

Eight pieces of data X(7), X(15), . . . , X(63) composing a data set Q8 are output.

### Second Cycle:

Eight pieces of data X(0), X(8), . . . , X(56) composing a data set Q1 are output.

### Third Cycle:

Eight pieces of data X(1), X(9), . . . , X(57) composing a data set Q2 are output.

### Fourth Cycle:

Eight pieces of data X(2), X(10), . . . , X(58) composing a data set Q3 are output.

### Fifth Cycle:

Eight pieces of data X(3), X(11), . . . , X(59) composing a data set Q4 are output.

### Sixth Cycle:

Eight pieces of data X(4), X(12), . . . , X(60) composing a data set Q5 are output.

### Seventh Cycle:

Eight pieces of data X(5), X(13), . . . , X(61) composing a data set Q6 are output.

### Eighth Cycle:

Eight pieces of data X(6), X(14), . . . , X(62) composing a data set Q7 are output.

In other words, a signal X′(k) after a frequency spectrum shift is output as follows, depending on a value of k.

X′(0), X′(8), . . . , X′(56): First cycle

X′(1), X′(9), . . . , X′(57): Second cycle

X′(2), X′(10), . . . , X′(58): Third cycle

X′(3), X′(11), . . . , X′(59): Fourth cycle

X′(4), X′(12), . . . , X′(60): Fifth cycle

X′(5), X′(13), . . . , X′(61): Sixth cycle

X′(6), X′(14), . . . , X′(62): Seventh cycle

X′(7), X′(15), . . . , X′(63): Eighth cycle

The following relations hold here.

$$\begin{matrix}{X}^{′} ( k ) = X ( k - 1 + 64 ) & ( 0 \leq k < 1 ) \\ X ( k - 1 ) & ( 1 \leq k < 64 )\end{matrix}$$

A frequency-domain signal X′(k) obtained by adding a frequency offset of 1, with respect to a value of a frequency number k, to a frequency-domain signal X(k) in a direction toward high frequency is expressed as follows.

$$\begin{matrix}{X}^{′} ( k ) = X ( k - 1 + 64 ) & ( 0 \leq k < 1 ) \\ X ( k - 1 ) & ( 1 \leq k < 32 ) \\ 0 & ( 32 \leq k < 33 ) \\ X ( k - 1 ) & ( 33 \leq k < 64 )\end{matrix}$$

Consequently, an additional signal shift between different cycles is not required for generating the frequency-domain signal X′(k), and there is no need for an additional circuit for data sorting. In other words, the frequency spectrum of the frequency-domain signal X(k) (k=0, 1, . . . , 63) is shifted by 1 with respect to a value of a frequency number k, in a direction toward high frequency, to provide a desirable signal output order.

Thus, an output order of the FFT circuit can be controlled to provide a processing cycle shift, in accordance with the frequency offset setting 52.

The FFT device 30 includes a first data sorting processing unit 11, a first butterfly calculation processing unit 21, a second data sorting processing unit 16, a twiddle multiplication processing unit 31, a second butterfly calculation processing unit 22, and a read address generation unit 43. In the FFT device 30, the same reference sign is given to the same configuration in the FFT device 10, and detailed description thereof is omitted. The FFT device 30 performs pipeline processing on first data sorting processing, first butterfly calculation processing, second data sorting processing, twiddle multiplication processing, and second butterfly calculation processing.

The FFT device 30 has a configuration obtained by removing the third data sorting processing unit 13 from the configuration of the FFT device 10. The sorting processing, performed by the third data sorting processing unit 13 by referring to the read address 51 in the FFT device 10, is performed by the second data sorting processing unit 16 in the FFT device 30. In other words, the second data sorting processing unit 16 performs sorting of data sequences based on data dependence in an FFT processing algorithm, in accordance with a read address 55. In addition to the sorting described above, the second data sorting processing unit 16 further performs sorting processing on an output X(k) of the FFT device 30. The additional sorting enables a processing cycle shift of the output X(k) and the like for providing, for example, the aforementioned frequency spectrum shift.

Specifically, the second data sorting processing unit 16 sorts data, output from the first butterfly calculation processing unit 21 in the sequential order illustrated in FIG. 2, into the arbitrary data set bit-reversed order illustrated in FIG. 10, as an order of input to the twiddle multiplication processing unit 31.

The second data sorting processing unit 16 may be implemented with a similar configuration to the data sorting processing unit 200 illustrated in FIG. 6.

The twiddle multiplication processing unit 31 and the second butterfly calculation processing unit 22 do not change an order between data sets, and therefore the second butterfly calculation processing unit 22 outputs an FFT processing result X(k) in the arbitrary data set bit-reversed order illustrated in FIG. 10.

### Effects of Third Exemplary Embodiment

As described above, the FFT device 30 according to the present exemplary embodiment is able to output data in an arbitrary order by specifying the order by use of a frequency offset setting 56.

For example, in order to provide a spectrum shift for compensation of a frequency offset for output data X(k) (k=0, 1, . . . , N−1) in a succeeding stage of the FFT device 30, an order of output from the FFT circuit may be output in accordance with a frequency offset amount. Consequently, there is no need to add a circuit for performing additional sorting on the output.

Further, the only circuit to be added to make an output order of output data specifiable is the read address generation unit 43, and a circuit scale thereof is very small.

Therefore, increase in a circuit scale and power consumption as a whole, including processing in a succeeding stage, can be suppressed.

Furthermore, compared with the FFT device 10, the third data sorting processing unit 13 can be omitted. Consequently, a circuit scale and power consumption can be further reduced.

Note that, while the FFT processing according to the present exemplary embodiment has been described as an example, the same holds for IFFT. In other words, processing in a succeeding stage of IFFT processing can be accelerated by applying the control method according to the present exemplary embodiment to an IFFT processing device, and optimizing an output order of a processing result in consideration of the processing content in the succeeding stage of the IFFT processing.

Note that, when applying the method according to the present exemplary embodiment to IFFT processing, an output order of an IFFT processing result is specified by a “time offset amount” as a temporal shift amount instead of a “frequency offset amount” according to the present exemplary embodiment. Thus, the present exemplary embodiment changes an output order of a result of FFT processing or IFFT processing, depending on a frequency-based or time-based “shift amount,” respectively.

### Fourth Exemplary Embodiment

In contrast to the third exemplary embodiment, a processing result of a preceding stage of FFT/IFFT processing may be input to an FFT/IFFT processing device in an arbitrary order. Consequently, for example, a processing result of the preceding stage of the FFT/IFFT processing may be input to a processing device performing processing, requiring a processing cycle shift such as a frequency spectrum shift, in a desirable order for the processing. In this case, it is effective for acceleration of the FFT/IFFT processing and suppression of increase in a circuit scale and power consumption to sort the input processing result of the preceding stage into an order suitable for the FFT/IFFT processing.

An IFFT device according to a fourth exemplary embodiment operating in accordance with the arbitrary data set bit-reversed order, as a desirable order for providing a processing cycle shift, will be described.

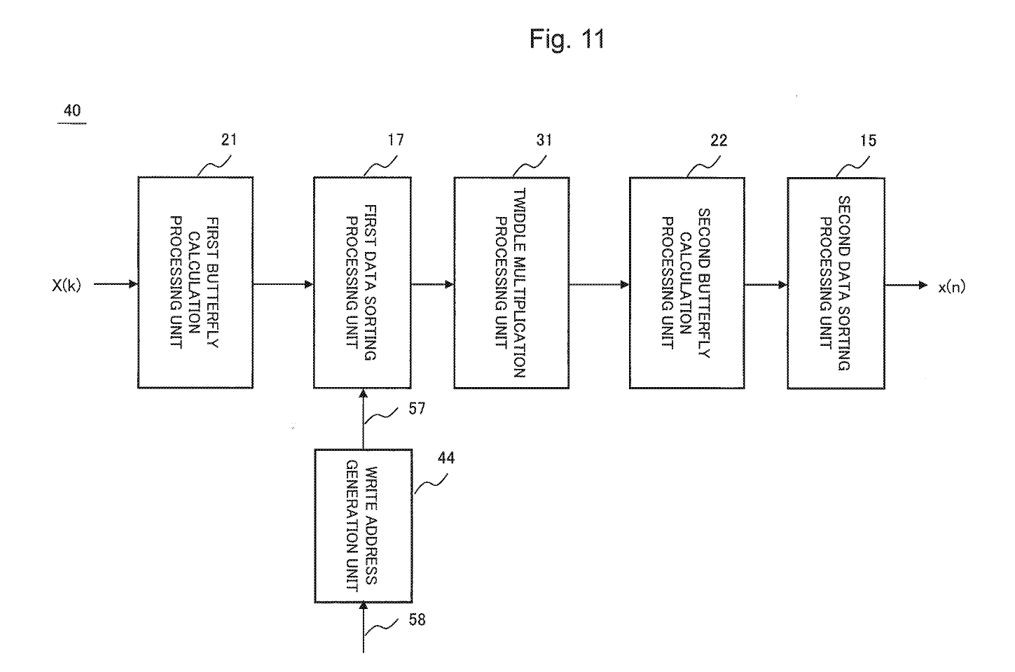

FIG. 11 is a block diagram illustrating a configuration example of the IFFT device 40 according to the fourth exemplary embodiment of the present invention. The IFFT device 40 processes a 64-point IFFT broken down into sets of two-stage radix-8 butterfly processing, in accordance with a data flow similar to the FFT data flow illustrated in FIG. 14, by a pipeline circuit method. When a frequency-domain signal X(k) (k=0, 1, . . . , N−1) Fourier-transformed by the FFT device 30 is input, the IFFT device 40 generates time-domain data y(n) (n=0, 1, . . . , N−1) by inverse-Fourier-transforming X(k), and outputs the data. Note that N is a positive integer denoting an IFFT block size.

In FIG. 7, the IFFT device 40 performs 64-point IFFT processing in 8-data-parallel. An input X(k) is input to the IFFT device 40 in the arbitrary data set bit-reversed order illustrated in FIG. 10, similar to an output of the FFT device 30. Then, the IFFT device 40 outputs an output y(n) in the sequential order illustrated in FIG. 2.

The IFFT device 40 includes a first butterfly calculation processing unit 21, a first data sorting processing unit 17, a twiddle multiplication processing unit 31, a second butterfly calculation processing unit 22, a second data sorting processing unit 15, and a write address generation unit 44. In the IFFT device 40, the same reference sign is given to the same configuration in the IFFT device 20, and detailed description thereof is omitted. The IFFT device 40 performs pipeline processing on first butterfly calculation processing, first data sorting processing, twiddle multiplication processing, second butterfly calculation processing, and second data sorting processing.

The IFFT device 40 has a configuration obtained by removing the first data sorting processing unit 14 from the configuration of the IFFT device 20. The sorting processing, performed by the first data sorting processing unit 14 by referring to the write address 53 in the IFFT device 20, is performed by the second data sorting processing unit 17 in the IFFT device 40. In other words, the second data sorting processing unit 17 performs sorting of data sequences based on data dependence in an IFFT processing algorithm, in accordance with a write address 57. In addition to the sorting described above, the second data sorting processing unit 17 further performs sorting processing for data input in the arbitrary data set sequential order.

Specifically, the second data sorting processing unit 17 sorts data, output from the first butterfly calculation processing unit 21 in the arbitrary data set sequential order in FIG. 4, into the bit-reversed order in FIG. 3, as an order of input to the second butterfly calculation processing unit 22.

The second data sorting processing unit 17 may be implemented with a similar configuration to the data sorting processing unit 300 illustrated in FIG. 8.

### Effects of Fourth Exemplary Embodiment

As described above, the IFFT device 40 according to the present exemplary embodiment is able to input data in a desirable order for providing a processing cycle shift for a frequency spectrum shift and the like, by specifying the order by use of a frequency offset setting 58. Consequently, there is no need for additional sorting means with respect to input, adapting to an output order of the FFT device 30.

Further, the only circuit to be added to adapt to input data, input in an arbitrary order, is the write address generation unit 44, and a circuit scale thereof is very small.

Therefore, increase in circuit scale and power consumption as a whole, including processing in a preceding stage, can be suppressed.

Furthermore, compared with the IFFT device 20, the first data sorting processing unit 14 can be omitted. Consequently, a circuit scale and power consumption can be further reduced.

Note that, while the IFFT processing according to the present exemplary embodiment has been described as an example, the same holds for FFT. In other words, FFT processing can be accelerated by applying the control method according to the present exemplary embodiment to an FFT processing device, and optimizing an input order of an input signal in consideration of processing content in a preceding stage of the FFT processing.

When applying the method according to the present exemplary embodiment to FFT processing, an input order of data to the FFT processing is specified by a “time offset amount” as a temporal shift amount instead of a “frequency offset amount” according to the present exemplary embodiment. Thus, the present exemplary embodiment changes an input order of data to IFFT processing or FFT processing, depending on a frequency-based or time-based “shift amount,” respectively.

As is obvious from the description above, a characteristic of the fast Fourier transform device according to the present invention is a capability to sort data into an arbitrary order desirable for providing a processing cycle shift, before or after FFT/IFFT transformation. Thus, acceleration of processing after data sorting is enabled. When an FFT/IFFT is performed in a plurality of stages of processing, data sorting may be performed between processing in a certain stage and processing in the next stage.

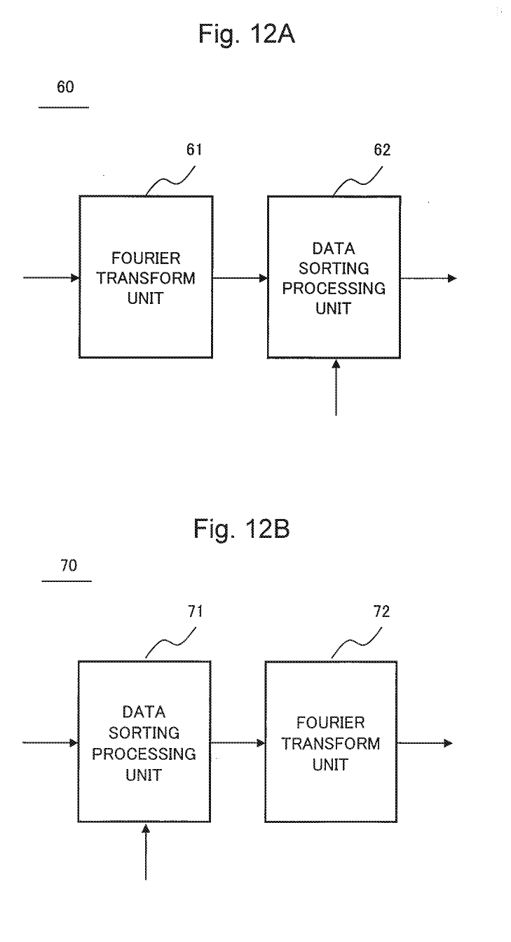

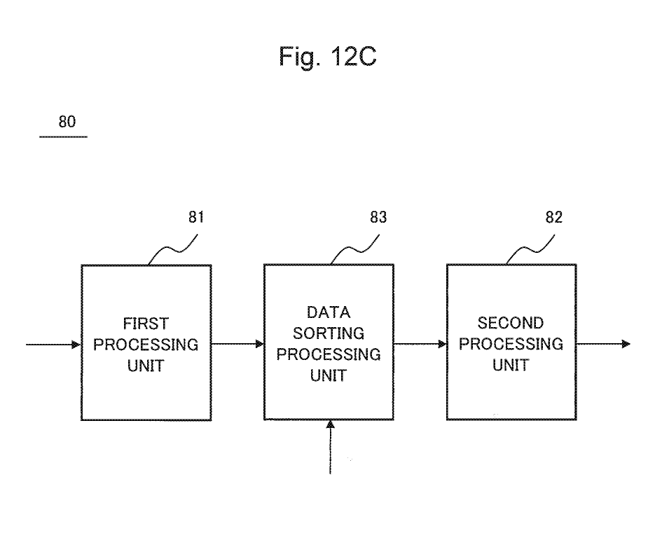

FIGS. 12A, 12B, and 12C are block diagrams illustrating essential configurations included in fast Fourier transform devices according to the present invention.

A fast Fourier transform device 60 includes a Fourier transform unit 61 and a data sorting processing unit 62. The Fourier transform unit 61 performs either fast Fourier transform or inverse fast Fourier transform to generate a plurality of pieces of output data, and outputs the data in a first order. The data sorting processing unit 62 sorts a plurality of pieces of first output data, output in the first order, into a second order, in accordance with a shift amount setting. Thus, the fast Fourier transform device 60 performs data sorting after Fourier transform. Note that a “shift amount” is a “frequency offset” when the Fourier transform unit 61 performs fast Fourier transform, and is a “time offset” when the Fourier transform unit 61 performs inverse fast Fourier transform.

A fast Fourier transform device 70 includes a Fourier transform unit 72 and a data sorting processing unit 71. The data sorting processing unit 71 sorts a plurality of pieces of input data, input in a third order, into a fourth order, in accordance with a shift amount setting. The Fourier transform unit 72 performs fast Fourier transform or inverse fast Fourier transform on a plurality of pieces of input data sorted in the fourth order. Thus, the fast Fourier transform device 70 performs data sorting before Fourier transform.

A fast Fourier transform device 80 includes processing units 81 and 82, and a data sorting processing unit 831. The fast Fourier transform device 80 performs fast Fourier transform or inverse fast Fourier transform in two stages by use of the processing units 81 and 82. The processing unit 81 generates a plurality of pieces of intermediate data and outputs the data in a fifth order. The data sorting processing unit 83 sorts a plurality of pieces of intermediate data, input in the fifth order, into a sixth order, in accordance with an order setting. The processing unit 82 performs predetermined processing on a plurality of pieces of intermediate data sorted in the sixth order, and generates output data which is the result of the fast Fourier transform or the inverse fast Fourier transform. Thus, in the fast Fourier transform device 80, data sorting is performed in an intermediate stage of fast Fourier transform processing or inverse fast Fourier transform processing.

### Fifth Exemplary Embodiment

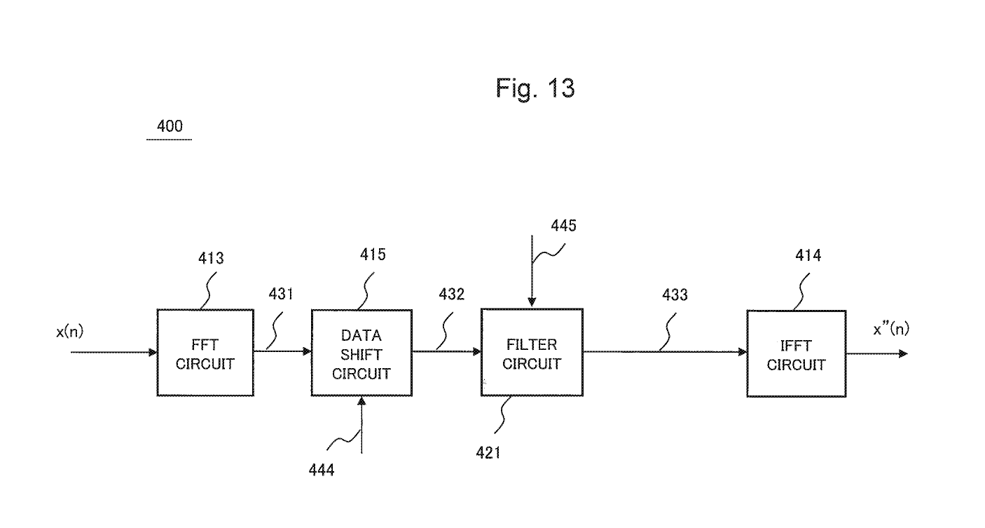

FIG. 13 is a block diagram illustrating a configuration example of a digital filter circuit 400 according to a fifth exemplary embodiment of the present invention. The digital filter circuit 400 includes an FFT circuit 413, an IFFT circuit 414, a data shift circuit 415, and a filter circuit 421.

The digital filter circuit 400 inputs a time-domain complex signal

x(n)=r(n)+js(n) (1).

The FFT circuit 413 transforms the input complex signal x(n) into a frequency-domain complex signal 431

X(k)=A(k)+jB(k) (2)

### by FFT.

Note that n is an integer denoting a signal sample number in a time domain, where 0≦n≦N−1, N is an integer denoting a number of FFT transform samples, where 0<N, and k is an integer denoting a frequency number in a frequency domain, where 0≦k≦N−1.

The data shift circuit 415 shifts an output cycle of the input complex signal 431, in accordance with a cycle shift amount signal 444, and outputs the signal as a complex signal 432. Further, the data shift circuit 415 replaces part of the input complex signal 431 with a value “0,” in accordance with the cycle shift amount signal 444, and outputs the signal as the complex signal 432.

Specifically, the data shift circuit 415 outputs a frequency-domain signal X′(k) (k=0, 1, . . . , N−1)(complex signal 432) in an output cycle obtained by shifting an input cycle of a frequency-domain signal X(k) (k=0, 1, . . . , N−1)(complex signal 431) by a shift amount D (where D is an integer). The data shift circuit 415 performs a shift of the output cycle and replacement with a value “0” so that the signal X′(k) is expressed as follows, depending on the sign of D.

1) When D>0 (cycle shifted in a direction toward high frequency)

$$\begin{matrix}{X}^{′} ( k ) = X ( k - D + N ) & ( when 0 \leq k < D ) \\ X ( k - D ) & ( when D \leq k < N / 2 ) \\ 0 & ( when N / 2 \leq k < N / 2 + D ) \\ X ( k - D ) & ( when N / 2 + D \leq k < N )\end{matrix}$$

2) When D<0 (cycle shifted in a direction toward low frequency)

$$\begin{matrix}{X}^{′} ( k ) = X ( k - D ) & ( when 0 \leq k < N / 2 + D ) \\ 0 & ( when N / 2 + D \leq k < N / 2 ) \\ X ( k - D ) & ( when N / 2 \leq k < N + D ) \\ X ( k - D - N ) & ( when N + D \leq k < N )\end{matrix}$$

3) When D=0 (no shift)

X′(k)=X(k)(0≦k<N)

Next, the filter circuit 421 performs complex filter processing by complex multiplication on X(k) output from the data shift circuit 415 as the complex signal 432, by use of a filter coefficient C1(k) input by a filter coefficient signal 445. Specifically, the filter circuit 421 calculates a complex signal

X′(k)=X(k)×C1(k) (3)

for each frequency number k, where 0≦k≦N−1, and outputs the signal as a complex signal 433.

Next, the IFFT circuit 414 generates a time-domain complex signal x″(n) from the input complex signal 433 by IFFT for each frequency number k, where 0≦k≦N−1, and outputs the signal.

As an implementation method of the FFT circuit 413, the FFT circuit 10 according to the first exemplary embodiment of the present invention may be used. Similarly, as an implementation method of the IFFT circuit 414, the IFFT circuit 20 according to the second exemplary embodiment of the present invention may be used.

Alternatively, as an implementation method of the FFT circuit 413, the FFT circuit 20 according to the third exemplary embodiment of the present invention may be used. Similarly, as an implementation method of the IFFT circuit 414, the IFFT circuit 40 according to the fourth exemplary embodiment of the present invention may be used.

As described above, the digital filter circuit 400 FFT transforms a time-domain input signal and generates a frequency-domain complex signal. Then, the digital filter circuit 400 causes the data shift circuit 415 to perform output cycle shift processing of signal data on the frequency-domain complex signal, in accordance with the cycle shift amount signal 444. Then, predetermined filter processing is performed by the filter circuit 421, and the result is transformed into a time-domain signal by the IFFT circuit 414.

### Effects of Fifth Exemplary Embodiment

As described above, the present exemplary embodiment provides a processing cycle shift by the data shift circuit performing shift processing of signal data on a frequency-domain complex signal, in accordance with a cycle shift amount setting value. Thus, acceleration of processing requiring a processing cycle shift, such as addition of a frequency offset, is provided.

Furthermore, the FFT circuit 10 according to the first exemplary embodiment of the present invention and the IFFT circuit 20 according to the second exemplary embodiment of the present invention may be used for implementation of the FFT circuit and the IFFT circuit, respectively. Alternatively, the FFT circuit 30 according to the third exemplary embodiment of the present invention and the IFFT circuit 40 according to the fourth exemplary embodiment of the present invention may be used for implementation of the FFT circuit and the IFFT circuit, respectively. As described above, the FFT circuit and the IFFT circuit according to the exemplary embodiments of the present invention are capable of reducing a circuit scale and power consumption for performing FFT processing and IFFT processing, respectively. In this case, there is no need for the data shift circuit 415 to sort signal data between different cycles, and therefore there is an effect that a circuit scale and power consumption for performing filter processing can be reduced by using the FFT circuit or the IFFT circuit according to the exemplary embodiments of the present invention in filter processing.

It is assumed that each set of processing according to the first to the fifth exemplary embodiments, such as FFT, IFFT, generation and composition of a complex conjugate, calculation of a filter coefficient, and filter processing, is processed by a separate component such as a circuit. However, processing according to each exemplary embodiment may be performed by a computer included in a given device, such as software using a digital signal processor (DSP) and the like. In other words, a computer program performing each set of processing is read and executed by a DSP (not illustrated).

For example, data sorting processing may be performed by use of a program. In other words, by use of a DSP and a memory, data sorting processing may be performed by a program controlling data writing to the memory and data reading from the memory.

Furthermore, the FFT processing according to the first and third exemplary embodiments and the IFFT processing according to the second and the fourth exemplary embodiments may be performed by use of a program. The FFT processing, the data shift processing, the filter processing, and the IFFT processing according to the fifth exemplary embodiment may be performed by use of a program.

Performing each set of processing by use of a program as described above still provides similar processing to the processing according to the aforementioned exemplary embodiments. Additionally, the program may be stored in a semiconductor storage device such as a read only memory (ROM), a random access memory (RAM), and a flash memory, and a nontemporary medium such as an optical disk, a magnetic disk, and a magneto-optical disk.

Furthermore, each of the aforementioned exemplary embodiments may be combined with another exemplary embodiment.

The whole or part of the exemplary embodiments disclosed above can be described as, but not limited to, the following supplementary notes.

(Supplementary Note 1)

A fast Fourier transform device comprising:

first transform means for performing fast Fourier transform or inverse fast Fourier transform to generate a plurality of pieces of first output data, and outputting the data in a first order; and

first data sorting processing means for sorting the plurality of pieces of first output data, output in the first order, into a second order, in accordance with an output order setting based on a first shift amount.

(Supplementary Note 2)

The fast Fourier transform device according to Supplementary Note 1, wherein

the first shift amount is a frequency shift amount when the first transform means performs fast Fourier transform, and is a time shift amount when the first transform means performs inverse fast Fourier transform.

(Supplementary Note 3)

The fast Fourier transform device according to Supplementary Note 1 or 2, wherein

the first transform processing means includes butterfly calculation processing means for performing butterfly calculation processing and outputting the plurality of pieces of first output data in the first order, and

the first data sorting processing means sorts the plurality of pieces of first data after the butterfly calculation processing into the second order.

(Supplementary Note 4)

The fast Fourier transform device according to any one of Supplementary Notes 1 to 3, wherein

the first data sorting processing means

includes first storage means for storing the plurality of pieces of first output data and read address generation means for generating a read address of the plurality of pieces of first output data from the first storage means, in accordance with the shift amount setting, and

stores the plurality of pieces of first output data in the first order and reads the data in the second order.

(Supplementary Note 5)

The fast Fourier transform device according to any one of

Supplementary Notes 1 to 4, wherein, when the plurality of pieces of first output data are given by X(k) (k is an integer, where 0≦k≦N−1, and N denotes a number of points of fast Fourier transform or inverse fast Fourier transform, where N>0), the first data sorting processing means outputs the data in an order specified by the output setting.

(Supplementary Note 6)

A fast Fourier transform device comprising:

second data sorting processing means for sorting a plurality of pieces of second input data, input in a third order, into a fourth order, in accordance with an input order setting based on a second shift amount; and

second transform means for performing fast Fourier transform or inverse fast Fourier transform on the plurality of pieces of second input data sorted in the fourth order.

(Supplementary Note 7)

The fast Fourier transform device according to Supplementary Note 6, wherein

the second shift amount is a time shift amount when the second transform means performs fast Fourier transform, and is a frequency shift amount when the second transform means performs inverse fast Fourier transform.

(Supplementary Note 8)

The fast Fourier transform device according to Supplementary Note 6 or 7, wherein

the second transform means includes butterfly calculation processing means for performing butterfly calculation processing, and

the second data sorting processing means inputs the plurality of pieces of second input data to the butterfly calculation processing means in the fourth order.

(Supplementary Note 9)

The fast Fourier transform device according to any one of Supplementary Notes 6 to 8, wherein

the second data sorting processing means

includes second storage means for storing the plurality of pieces of second input data and write address generation means for generating a write address of the plurality of pieces of second input data to the second storage means, in accordance with the input order setting,

stores the plurality of pieces of second input data in the third order, and reads the data in the fourth order.

(Supplementary Note 10)

The fast Fourier transform device according to any one of Supplementary Notes 6 to 9, wherein

when the plurality of pieces of first input data are given by X(k) (k is an integer, where 0≦k≦N−1, and N denotes a number of points of fast Fourier transform or inverse fast Fourier transform, where N>0), the second data sorting processing means inputs the data to the butterfly calculation processing means in an order specified by the input setting.

(Supplementary Note 11)

A filter device comprising the fast Fourier transform device according to Supplementary Note 1 or 6.

(Supplementary Note 12)

A fast Fourier transform method comprising:

performing sorting of a plurality of pieces of output data generated by fast Fourier transform or inverse fast Fourier transform, in accordance with an output order setting based on a first shift amount setting; or

performing sorting of a plurality of pieces of input data to the fast Fourier transform or the inverse fast Fourier transform, in accordance with an input order setting based on a second shift amount setting.

(Supplementary Note 13)

A fast Fourier transform program causing a computer included in a fast Fourier transform device to function as:

means for performing fast Fourier transform or inverse fast Fourier transform; and

sorting means for sorting a plurality of pieces of output data generated by the fast Fourier transform or the inverse fast Fourier transform, in accordance with an output order setting based on a first shift amount setting, or sorting means for sorting a plurality of pieces of input data to the fast Fourier transform or the inverse fast Fourier transform, in accordance with an input order setting based on a second shift amount setting.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-258271, filed on Dec. 13, 2013, the disclosure of which is incorporated herein in its entirety by reference.

### REFERENCE SIGNS LIST

10, 30 FFT device
20, 40 IFFT device
11, 12, 13, 14, 15, 16, 17 Data sorting processing unit
21, 22 Butterfly calculation processing unit
31 Twiddle multiplication processing unit
41, 43 Read address generation unit
42, 44 Write address generation unit
51, 55 Read address
52, 56 Frequency offset setting
53, 57 Write address
54, 58 Frequency offset setting
60, 70, 80 Fast Fourier transform device
61, 72 Fourier transform unit
62, 71, 83 Data sorting processing unit
81, 82 Processing unit
100, 200, 300 Data sorting processing unit
101a to 101h Data storage location
102a to 102h Data read location
201a to 201h Data storage location
301a to 301h Data storage location
400 Digital filter circuit
413 FFT circuit
414 IFFT circuit
415 Data shift circuit
421 Filter circuit
431 to 433 Complex signal
444 Cycle shift amount signal
445 Filter coefficient signal
500 Data flow
501 Data sorting processing
502, 503 Butterfly calculation processing
504 Twiddle calculation processing
505 Partial data flow
600 FFT device
601 FFT unit
602 Data sorting processing unit

What is claimed is:

1. A fast Fourier transform device comprising:
a first transform unit for performing fast Fourier transform or inverse fast Fourier transform to generate a plurality of pieces of first output data, and outputting the data in a first order; and
a first data sorting processing unit for sorting the plurality of pieces of first output data, output in the first order, into a second order, in accordance with an output order setting based on a first shift amount.

2. The fast Fourier transform device according to claim 1, wherein
the first transform processing unit includes butterfly calculation processing unit for performing butterfly calculation processing and outputting the plurality of pieces of first output data in the first order, and
the first data sorting processing unit sorts the plurality of pieces of first data after the butterfly calculation processing into the second order.

3. The fast Fourier transform device according to claim 1, wherein
the first data sorting processing unit
includes a first storage unit for storing the plurality of pieces of first output data and a read address generation unit for generating a read address of the plurality of pieces of first output data from the first storage unit, in accordance with the shift amount setting, and
stores the plurality of pieces of first output data in the first order and reads the data in the second order.

4. The fast Fourier transform device according to claim 1, wherein,
when the plurality of pieces of first output data are given by X(k) (k is an integer, where 0≦k≦N−1, and N denotes a number of points of fast Fourier transform or inverse fast Fourier transform, where N>0), the first data sorting processing unit outputs the data in an order specified by the output setting.

5. A fast Fourier transform device comprising:
a second data sorting processing unit for sorting a plurality of pieces of second input data, input in a third order, into a fourth order, in accordance with an input order setting based on a second shift amount; and
a second transform unit for performing fast Fourier transform or inverse fast Fourier transform on the plurality of pieces of second input data sorted in the fourth order.

6. The fast Fourier transform device according to claim 5, wherein
the second transform unit includes a butterfly calculation processing unit for performing butterfly calculation processing, and
the second data sorting processing unit inputs the plurality of pieces of second input data to the butterfly calculation processing unit in the fourth order.

7. The fast Fourier transform device according to claim 5, wherein
the second data sorting processing unit
includes a second storage unit for storing the plurality of pieces of second input data and a write address generation unit for generating a write address of the plurality of pieces of second input data to the second storage unit, in accordance with the input order setting,
stores the plurality of pieces of second input data in the third order, and reads the data in the fourth order.

8. A digital filter device comprising the fast Fourier transform device according to claim 1.

9. A fast Fourier transform method comprising:
performing sorting of a plurality of pieces of output data generated by fast Fourier transform or inverse fast Fourier transform, in accordance with an output order setting based on a first shift amount setting; or
performing sorting of a plurality of pieces of input data to the fast Fourier transform or the inverse fast Fourier transform, in accordance with an input order setting based on a second shift amount setting.

10. (canceled)

11. The fast Fourier transform device according to claim 1, wherein
the first shift amount is a frequency shift amount when the first transform unit performs fast Fourier transform, and is a time shift amount when the first transform unit performs inverse fast Fourier transform.

12. The fast Fourier transform device according to claim 5, wherein
the second shift amount is a time shift amount when the second transform unit performs fast Fourier transform, and is a frequency shift amount when the second transform unit performs inverse fast Fourier transform.

13. The fast Fourier transform device according to claim 6, wherein
when the plurality of pieces of first input data are given by X(k) (k is an integer, where 0≦k≦N−1, and N denotes a number of points of fast Fourier transform or inverse fast Fourier transform, where N>0), the second data sorting processing unit inputs the data to the butterfly calculation processing unit in an order specified by the input setting.
